(19) United States
(12) Patent Application Publication
(10) Pub. No.: US 2015/0259896 A1
(43) Pub. Date: Sep. 17, 2015

(54) CONNECTOR PIPE SCREENS FOR STORM DRAINS

(71) Applicant: Ernest Jarvis, Norco, CA (US)

(72) Inventor: Ernest Jarvis, Norco, CA (US)

(21) Appl. No.: 14/209,168

(22) Filed: Mar. 13, 2014

(51) Int. Cl. E03F 5/14; B01D 35/14

(52) U.S. Cl. CPC E03F 5/14; B01D 35/14

(57) ABSTRACT

Embodiments of the invention provide connector pipe screens, configured for installation into a catch basin of a storm drain, that comprise rotatably mounted resistance screens having a bias toward occupying a closed position.

### FIELD OF THE INVENTIONS

The present invention generally relates to storm drain filters, and in particular to storm drain connector pipe screen (CPS) filters. Preferred CPSs of the invention possess rotatably mounted screens that have a positive bias toward occupying the closed position.

### BACKGROUND OF THE INVENTIONS

Primary functions of storm water conveyance systems include the prevention of erosion and flooding by channeling surface water runoffs into networks of underground pipes and/or open channels for controlled distribution. Surface water runoffs taken into storm water conveyance systems can be directed to water treatment facilities and/or open bodies of water, such as rivers, lakes, and oceans. Storm drains represent the intake point of surface water runoffs into the storm water conveyance system.

Surface water runoff enters a storm drain through an opening called a storm drain inlet. Typically, the storm drain inlet allows water to run into a catch basin. And the catch basins have an intake opening and an outlet pipe that provides a path for water to run from the catch basin into the remainder of the storm water conveyance system.

Debris removal is an important function of storm drain filtration systems because debris entering storm drains along with surface water runoff may clog storm drains, resulting in flooding, or run through storm drains, resulting in damage to water treatment facilities and/or pollution of receiving water bodies. Storm drains can incorporate a variety of filter systems designed to reduce the amount of debris that enters the storm drain and/or the storm water conveyance system. Examples of such filtering systems include storm drain inlet screens, catch basin filters, pre-treatment filters, and connector pipe screens.

While storm drain filtration systems should inhibit debris and trash from entering into the storm drain and/or storm water conveyance system, they should not interfere with the primary functions of the conveyance system, which is the prevention of erosion and flooding. One strategy for achieving these objectives are storm drain filtration systems comprising screens that occupy a closed position under dry conditions, or conditions of low or moderate water flow, and an open position under conditions of moderate to heavy water flow. In such systems, screens in the closed position impede the passage of debris while permitting low to moderate water flow; and screens in the open position allow the passage of debris and water such that the screens themselves do not plug the storm drains and cause flooding.

In the context of curb inlet filtration units, debris detained by such screens when there is no, low, or moderate water flow can be removed by a street sweeper, keeping the removed debris out the storm drain and the storm water conveyance system. In the context of connector pipe filtration units, debris detained by such screens when there is low to moderate water flow can be removed from the catch basin of the storm drain by maintenance crews, keeping the removed debris out of the remainder of the storm drain and/or storm water conveyance system.

### SUMMARY OF THE INVENTIONS

A typical storm drain comprises a curb inlet and a catch basin, and a connector pipe in sealed connection with the catch basin places the storm drain in fluid communication with the remainder of the storm water conveyance system. The catch basin typically comprises an opening for the connector pipe in a side wall in proximity with the floor of the catch basin or in the floor of the catch basin. Connector pipe screens are installed into the wall and/or floor of the catch basin, inline with a fluid flow path from the catch basin into the connector pipe, such that water entering the catch basin flows through the connector pipe screen prior to flowing out of the catch basin through the connector pipe. Prior connector pipe screens typically comprise a formed stainless steel perforated screen (e.g., 14 gauge) which may be fixedly supported by a stainless steel frame.

During periods of moderate to heavy rain large volumes of water, often carrying debris such as rock, wood, and particulate matter, can rush into the curb inlet of a storm drain and fall several feet into the catch basin prior to impacting the floor or reservoir of water in the catch basin with high pressure and force. Under such conditions, prior connector pipe screens frequently collapse, potentially into the connector pipe causing blockage and flooding.

The present invention provides connector pipe screens that incorporate one or more openings into which perforated screens are rotatably mounted. Rotatably mounted screens of the invention are configured to have a bias toward occupying the closed position. In the closed position, rotatably mounted screens of the invention assist the connector pipe screens that comprise them to impede debris from entering the surface runoff water conveyance infrastructure. Rotatably mounted screens of the invention are further configured such that their bias toward occupying the closed position can be overcome by pressure exerted thereon, by moderate to high flows of surface water runoff passing through storm drains into which they are installed. In the open position, rotatably mounted screens of the invention allow significantly greater amounts of water to flow through connector pipe screens of the invention that comprise them. This, in turn, facilitates connector pipe screens of the invention, installed in storm drains, to assist them in performing their primary functions of preventing erosion and flooding by channeling runoff surface water into stormwater conveyance infrastructure for controlled distribution.

Embodiments of the present invention provide a connector pipe screen (CPS), configured for installation into a storm drain catch basin and substantially shaped as a box that is open on a top side, a bottom side, a lateral side, and a back side. Such CPSs can comprise a resistance hanging screen swingably mounted on a metal frame that forms a front panel and a lateral panel and comprises a first mounting plate, a second mounting plate, a first resistance screen mount, and a second resistance screen mount. In such CPSs, the front panel fixedly adjoins the lateral panel, and the first mounting plate fixedly adjoins the front panel and is adapted to fixedly mount the connector pipe screen to a first wall of the catch basin. In such CPSs, the second mounting plate fixedly adjoins the lateral panel and is adapted to fixedly mount the connector pipe screen to a second wall of the catch basin; and each of the lateral panel and the front panel comprises a shape of a rectangle, a perimeter of each rectangle is comprised of the metal frame and an interior of each rectangle is comprised of a screen that: i. is fixedly mounted to at least a portion of the perimeter, and ii. comprises a plurality of perforations adapted in size and shape to permit water to pass through the screen and impede debris from passing through the screen.

Also in such CPSs, at least one of the front panel and the lateral panel further comprises an opening formed by the metal frame and positioned above at least a portion of the rectangle of the front panel or the lateral panel, the opening adapted in size and shape to fittingly receive the resistance hanging screen. The first and second resistance screen pivot mounts are positioned on opposite lateral sides of the metal frame that form the opening and project frontward of the metal frame. The resistance hanging screen comprises a rectangular or square resistance screen frame, a perforated resistance screen fixedly mounted to the resistance screen frame, a first pivot mounting plate, and a second pivot mounting plate. The perforations of the resistance screen are adapted in size and shape to permit water to pass through the resistance screen while impeding debris from passing through. The first and second pivot mounting plates are positioned opposite each other on lateral sides of the resistance screen frame and project frontward of the resistance screen frame. The first and second resistance screen mounts and the first and second pivot mounting plates comprise openings through which the shaft of a first hanging pivot and the shaft of a second hanging pivot passes respectively, such that the hanging resistance screen is swingably mounted in the rectangular opening of the front section. A majority of the mass of the resistance hanging screen resides in the resistance screen frame and the resistance screen, such that the center of gravity of the resistance hanging screen is located between the resistance screen and a plane that is parallel to the resistance screen and bisects the shafts of each of the first and second hanging pivots. And the combination of having a so-located center of gravity and being swingably mounted in the rectangular opening of the front section of the metal frame results in the resistance hanging screen having a bias towards occupying a closed position.

Embodiments of the present invention comprise CPSs, configured for installation into a storm drain catch basin and substantially shaped as a box that is open on a top side, a bottom side, and a back side. Such CPSs can comprise a resistance hanging screen swingably mounted on a metal frame that forms a front panel, a first lateral panel, a second lateral panel, and comprises a first mounting plate, a second mounting plate, a first resistance screen mount, and a second resistance screen mount. In such CPSs, the front panel fixedly adjoins each of the first lateral panel and the second lateral panel. The first mounting plate fixedly adjoins the first lateral panel and is adapted to fixedly mount the connector pipe screen to a wall of the catch basin. The second mounting plate fixedly adjoins the second lateral panel and is adapted to fixedly mount the connector pipe screen to the wall of the catch basin. Each of the first lateral panel, the front panel, and the second lateral panel comprises a shape of rectangle, a perimeter of each rectangle comprised of the metal frame and an interior of each rectangle comprised of a screen that: i. is fixedly mounted to at least a portion of the perimeter, and ii. comprises a plurality of perforations adapted in size and shape to permit water to pass through the screen and impede at least some debris from passing through the screen.

Also in such CPSs, at least one of the first lateral panel, the second lateral panel, and the front panel further comprises an opening formed by the metal frame and positioned above at least a portion of the rectangle of the first lateral panel, the second lateral panel, or the front panel, the opening adapted in size and shape to fittingly receive the resistance hanging screen. The first and second resistance screen pivot mounts are positioned on opposite lateral sides of the metal frame that form the opening and project frontward of the metal frame. The resistance hanging screen comprises a rectangular or square resistance screen frame, a resistance screen fixedly mounted to the resistance screen frame, a first pivot mounting plate, and a second pivot mounting plate. The resistance screen comprises a plurality of perforations adapted in size and shape to permit water to pass through the resistance screen and impede at least some debris from passing through the resistance screen. The first and second pivot mounting plates are positioned on opposite each other on lateral sides of the resistance screen frame and project frontward of the resistance screen frame. The first and second resistance screen mounts and the first and second pivot mounting plates comprise openings through which the shaft of a first hanging pivot and the shaft of a second hanging pivot passes respectively, such that the hanging resistance screen is swingably mounted in the rectangular opening of the front section. A majority of the mass of the resistance hanging screen resides in the resistance screen frame and the resistance screen, such that the center of gravity of the resistance hanging screen is located between the resistance screen and a plane that is parallel to the resistance screen and bisects the shafts of each of the first and second hanging pivots. And the combination of having a so-located center of gravity and being swingably mounted in the rectangular opening of the front section of the metal frame results in the resistance hanging screen having a bias towards occupying a closed position.

Embodiments of the present invention provided CPSs, configured for installation into a storm drain catch basin and substantially shaped as a box that is open on a top side, a bottom side, a lateral side, and a back side. Such CPSs comprise a resistance hanging screen swingably mounted on a metal frame that forms a front panel and a lateral panel, and comprises a first mounting plate, a second mounting plate, a first resistance screen mount, and a second resistance screen mount. In such CPSs, the front panel fixedly adjoins the lateral panel. The first mounting plate fixedly adjoins the front panel and is adapted to fixedly mount the connector pipe screen to a first wall of the catch basin. The second mounting plate fixedly adjoins the lateral panel and is adapted to fixedly mount the connector pipe screen to a second wall of the catch basin. Each of the lateral panel and the front panel comprises a shape of a rectangle, a perimeter of each rectangle comprised of the metal frame and an interior of each rectangle comprised of a screen that: i. is fixedly mounted to at least a portion of the perimeter, and ii. comprises a plurality of perforations adapted in size and shape to permit water to pass through the screen and impede at least some debris from passing through the screen.

Also in such CPSs, at least one of the front panel and the lateral panel further comprises an opening formed by the metal frame and positioned above at least a portion of the rectangle of the front panel or the lateral panel, the opening adapted in size and shape to fittingly receive the resistance hanging screen. The first and second resistance screen pivot mounts are positioned on opposite lateral sides of the metal frame that form the opening and project frontward of the metal frame. The resistance hanging screen comprises a rectangular or square resistance screen frame, a resistance screen fixedly mounted to the resistance screen frame, a first pivot mounting plate, and a second pivot mounting plate. The resistance screen comprises a plurality of perforations adapted in size and shape to permit water to pass through the resistance screen and impede at least some debris from passing through the resistance screen. The first and second pivot mounting plates are positioned opposite each other on lateral sides of the resistance screen frame and are substantially in line with the resistance screen frame. The first and second resistance screen mounts and the first and second pivot mounting plates comprise openings through which the shaft of a first hanging pivot and the shaft of a second hanging pivot passes respectively, such that the hanging resistance screen is swingably mounted in the rectangular opening of the front section. The resistance hanging screen comprises a counterbalance assembly that projects rearwards from the resistance screen frame. A majority of the mass of the resistance hanging screen resides in the counterbalance assembly, such that the center of gravity of the resistance hanging screen is located between the resistance screen and a plane that is parallel to the resistance screen and bisects the counterbalance assembly. And the combination of having a so-located center of gravity and being swingably mounted in the rectangular opening of the front section of the metal screen results in the resistance hanging screen having a bias towards occupying a closed position.

Embodiments of the invention provide CPSs, configured for installation into a storm drain catch basin and substantially shaped as a box that is open on a top side, a bottom side, and a back side. Such CPSs comprise a resistance hanging screen swingably mounted on a metal frame that forms a front panel, a first lateral panel, a second lateral panel, and comprises a first mounting plate, a second mounting plate, a first resistance screen mount, and a second resistance screen mount. In such CPSs, the front panel fixedly adjoins each of the first lateral panel and the second lateral panel. The first mounting plate fixedly adjoins the first lateral panel and is adapted to fixedly mount the connector pipe screen to a wall of the catch basin. The second mounting plate fixedly adjoins the second lateral panel and is adapted to fixedly mount the connector pipe screen to the wall of the catch basin. Each of the first lateral panel, the front panel, and the second panel comprises a shape of rectangle, a perimeter of each rectangle comprised of the metal frame and an interior of each rectangle comprised of a screen that: i. is fixedly mounted to at least a portion of the perimeter, and ii. comprises a plurality of perforations adapted in size and shape to permit water to pass through the screen and impede at least some debris from passing through the screen.

Also in such CPSs, at least one of the first lateral panel, the second lateral panel, and the front panel further comprises an opening formed by the metal frame and positioned above at least a portion of the rectangle of the first lateral panel, the second lateral panel, or the front panel, the opening adapted in size and shape to fittingly receive the resistance hanging screen. The first and second resistance screen pivot mounts are positioned on opposite lateral sides of the metal frame that form the opening and are substantially in line with the metal frame. The resistance hanging screen comprises a rectangular or square resistance screen frame, a resistance screen fixedly mounted to the resistance screen frame, a first pivot mounting plate, and a second pivot mounting plate. The resistance screen comprises a plurality of perforations adapted in size and shape to permit water to pass through the resistance screen and impede at least some debris from passing through the resistance screen. The first and second pivot mounting plates are positioned opposite each other on lateral sides of the resistance screen frame and are substantially in line with the resistance screen frame. The first and second resistance screen mounts and the first and second pivot mounting plates comprise openings through which the shaft of a first hanging pivot and the shaft of a second hanging pivot passes respectively, such that the hanging resistance screen is swingably mounted in the rectangular opening of the front section. The resistance hanging screen comprises a counterbalance assembly that projects rearwards from the resistance screen frame. A majority of the mass of the resistance hanging screen resides in the counterbalance assembly, such that the center of gravity of the resistance hanging screen is located between the resistance screen and a plane that is parallel to the resistance screen and bisects the counterbalance assembly. And the combination of having a so-located center of gravity and being swingably mounted in the rectangular opening of the front section of the metal screen results in the resistance hanging screen having a bias towards occupying a closed position.

### BRIEF DESCRIPTION OF THE DRAWINGS

FIG. 1 is a front elevation view of a connector pipe screen of the invention that comprises a forward mounted resistance hanging screen, in a closed position.

FIG. 2 is a rear elevation view of a connector pipe screen of the invention that comprises a forward mounted resistance hanging screen, in an open position.

FIG. 3. is a rear elevation view of a connector pipe screen of the invention that comprises a counterbalanced resistance hanging screen, in a closed position

FIG. 4. is a front elevation view of a connector pipe screen of the invention installed into a storm drain

FIG. 5 is a rear elevation view of a connector pipe screen of the invention that comprises a counterbalanced resistance hanging screen and is configured for installation into a corner of a catch basin in a storm drain.

FIG. 6 is a front elevation view of an alternate construction connector pipe screen of the invention that comprises a forward mounted resistance hanging screen, in a closed position.

FIG. 7 is a rear elevation view of an alternate construction connector pipe screen of the invention that comprises a forward mounted resistance hanging screen and a counterbalance assembly, in an open position.

### DETAILED DESCRIPTION OF THE INVENTIONS

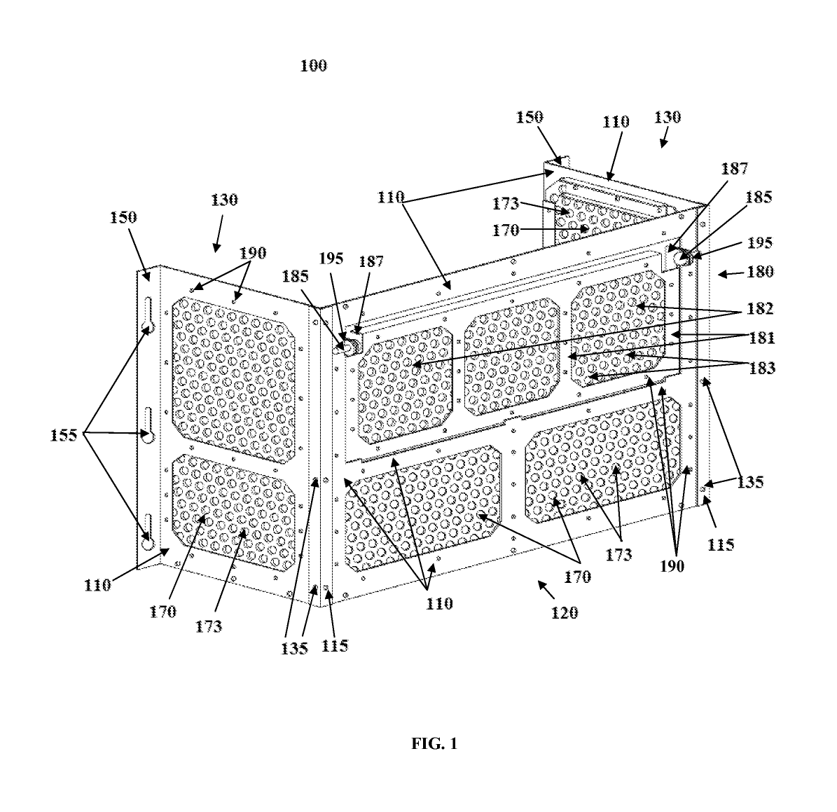

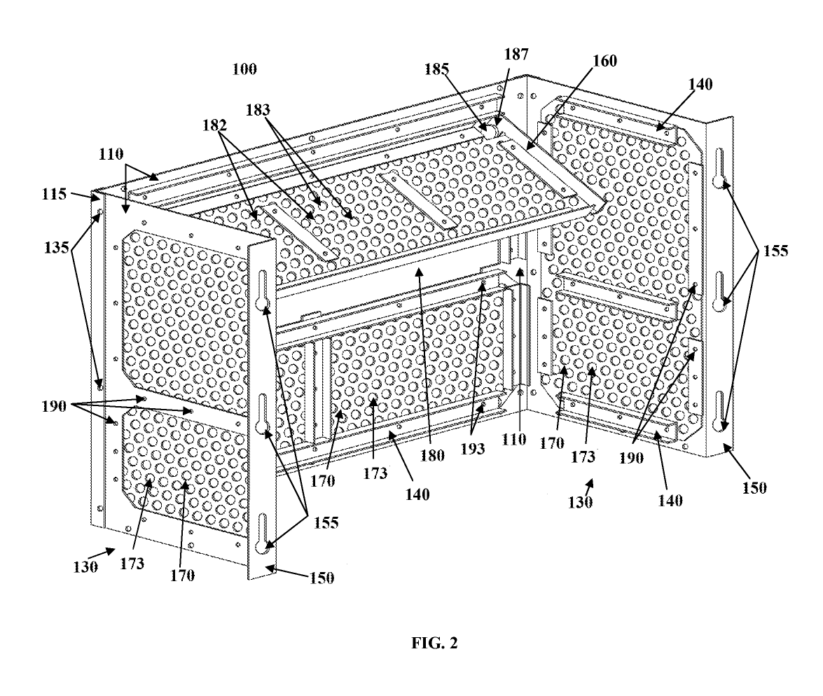

FIG. 1 is a front elevation view of an embodiment of a connector pipe screen 100 according to the invention that comprises a forward mounted resistance hanging screen 180 and is configured for installation into the catch basin of a storm drain. Connector pipe screen 100 possesses a metal frame 110 that forms a front panel 120, first and second lateral panels 130, first and second mounting plates 150, and first and second resistance hanging screen mounting cantilever brackets 160 (see FIG. 2). First and second resistance hanging screen mounting cantilever brackets 160 comprise pivot tabs 195 that project frontward from metal frame 110. Connector pipe screen 100 comprises an overall shape of a box that is open on three sides: i.e., the top side, the bottom side, and the back side (also see FIG. 2). Metal frame 110 is made from a single sheet of metal that has been: i. cut to form: a. rivet and screw openings, b. mounting cutouts 155, and c. the openings into which metal screens 170 and hanging resistance screen 180 are installed; and ii. formed into the illustrated shape.

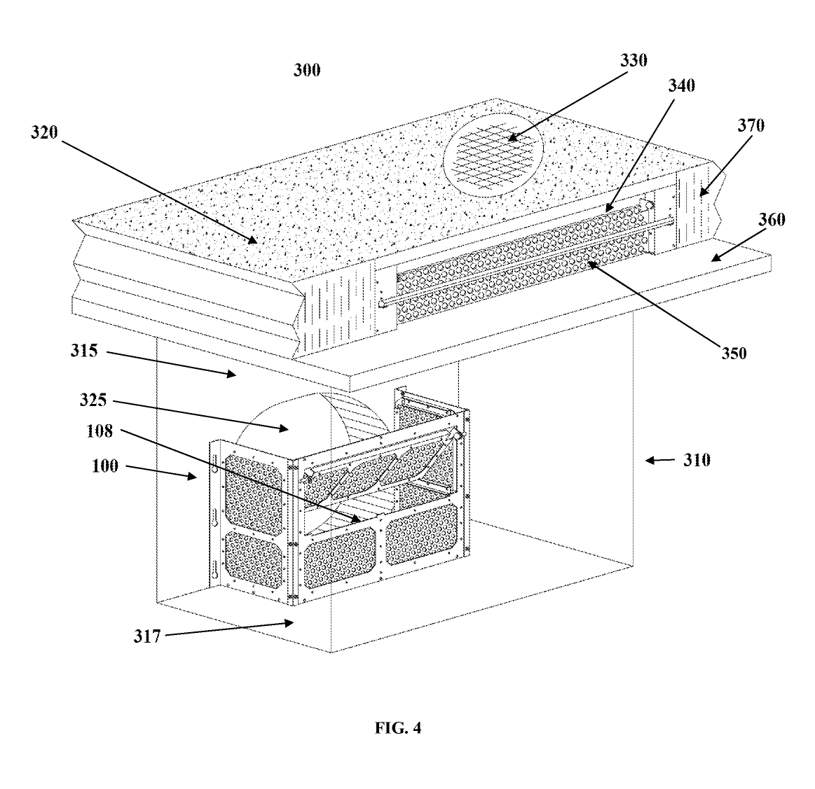

First and second mounting plates 150 possess mounting cutouts 155 adapted to receive bolts or screws for fixedly mounting connector pipe screen 100 into the catch basin of a storm drain (also see FIGS. 2 and 4). Metal screens 170 are made from stainless steel, comprise perforations 173 that are adapted in size and shape to allow water to flow through metal screens 170 and impede the flow of at least some water born debris through metal screens 170, and are attached to frame 110 with rivets 190.

Connector pipe screen 100 possesses front and lateral panel reinforcement and panel connection members 115 made of stainless steel and attached to metal frame 110 at the junctions of front panel 120 and first and second lateral panels 130 by screws 135. Reinforcement and panel connection members 115 are adapted to increase the strength of connector pipe screen 100. In some embodiments, connector pipe screens do not comprise reinforcement and panel connection members. In some embodiments metal screens and/or reinforcement and panel connection members are attached to frames by welding, rivets, bolts, clamps, pins, and the like.

Referring again to FIG. 1, resistance hanging screen 180 comprises resistance screen frame 181, which comprises first and second pivot mounting plates 187, and resistance screen 182, which comprises screen perforations 183 that are adapted in size and shape to allow water to flow through resistance screen 182 and impede the flow of at least some water born debris through resistance screen 182. Rivets 190 and U-channel structural support brackets 140 (see FIG. 2) fixedly attach metal screens 170 and 182 to metal frames 110 and 181, respectively. U-channel structural support brackets 140 are made of stainless steel.

Resistance screen frame 181 comprises a rectangular shape and is dimensioned for mounting into the opening therefore in metal frame 110. Resistance screen hanging pivots 185 swingably mount resistance hanging screen 180 into the opening therefor in metal frame 110 by passing through openings in resistance screen pivot tabs 195 and hanging pivot mounting plates 187. Resistance screen frame 181, hanging pivots 185, hanging pivot mounting plates 187, and resistance screen 182 are made of stainless steel.

A majority of the mass of resistance hanging screen 180 resides in resistance screen frame 181 and resistance screen 182; and hanging pivot mounting plates 187 project frontward of hanging screen 180 and metal frame 110. Accordingly, the center of gravity of resistance hanging screen 180 is located between resistance screen 182 and a plane that is parallel to resistance screen 182 and bisects hanging pivots 185, when resistance hanging screen 180 is in the illustrated closed position. The combination of having a so-located center of gravity and being swingably mounted in storm drain connector pipe screen 100 results in resistance hanging screen 180 having a bias towards occupying the illustrated closed position.

Such a closed position bias results in resistance hanging screen 180 having a tendency to remain closed under conditions of no to low water flow through resistance screen 182. Under conditions of no to low water flow through resistance screen 182, water pressure exerted on resistance screen 182 and resistance screen frame 181 is insufficient to overcome the closed position bias of resistance hanging screen 180. In a closed position, debris carried by water flowing through resistance screen 182 of a size too large to flow through perforations 183 is impeded from flowing through resistance hanging screen 180 such that it collects in the catch basin of a storm drain (see FIG. 4) into which connector pipe screen 100 is installed and without flowing into the connector pipe (see FIG. 4) of the storm drain. Such collected debris can be removed from the catch basin by maintenance crews. Accordingly, hanging resistance screen 180 reliably assumes a closed position in conditions of no to low water flow therethrough; and is therefore reliably operative for its intended filtering function.

Under conditions of moderate to high water flows through resistance hanging screen 180, water pressure exerted on resistance screen 182 and resistance screen frame 181 are sufficient to cause hanging resistance screen 180 to swing on hanging pivots 185 into an open position (see FIG. 2). In the open position, significantly increased amounts of water flow through connector pipe screen 100 than would flow if hanging resistance screen 180 were fixedly mounted to the connector pipe screen 100 in a closed position. In this way, hanging resistance screen 180 assists the storm drain into which connector pipe screen 100 is installed to perform its primary functions of preventing erosion and flooding by channeling runoff surface water into stormwater conveyance infrastructure for controlled distribution. Upon abatement of moderate to high water flows through resistance hanging screen 180, resistance hanging screen 180 swings with bias on hanging pivots 185 into the closed position.

FIG. 2 is a rear elevation view of the connector pipe screen illustrated in FIG. 1, with hanging resistance screen 180 in an open position. In this view, metal screen mounting brackets 150 are visible. Also visible are U-channel structural support brackets 140 through which rivets 190 pass in securing perforated screens 170 to metal frame 110.

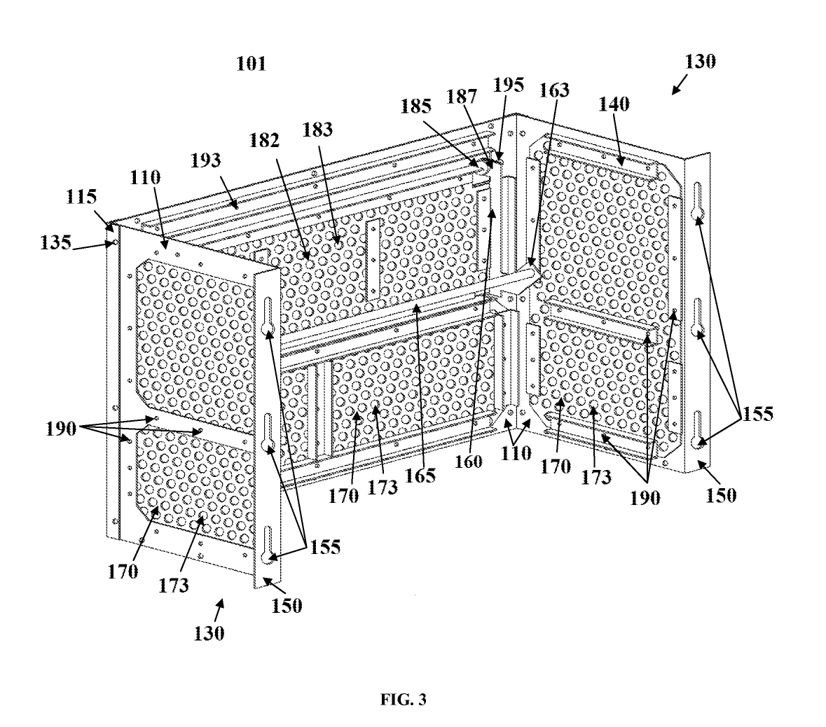

FIG. 3 is a rear elevation view of an embodiment of a connector pipe screen 101 that differs from the connector pipe screen illustrated in FIG. 2 by further possessing a counterbalance assembly, which comprises counterbalance tabs 163 (one visible in FIG. 3) and counterbalance bar 165. Counterbalance tabs 163 are made of stainless steel, are fixedly attached to the resistance screen frame, extend rearward from the resistance screen frame, and support counterbalance bar 165. Counterbalance bar 165 is also made of stainless steel and is fixedly attached to counterbalance tabs 163. The additional mass of the counterbalance balance assembly increases the bias towards occupying the closed position of the resistance hanging screen illustrated in FIG. 3 as compared to the embodiment illustrated in FIG. 2.

In some embodiments, counterbalance assemblies do not possess a counterbalance bar. In some embodiments, counterbalance tabs are made from the same piece of metal as a hanging resistance screen frame. In some embodiments, counterbalance tabs are made from different pieces of metal than the hanging resistance screen frame and are fixedly attached thereto by weld, rivet, bolt, screw, and the like. In some embodiments, counterbalance bars are fixedly attached to the counterbalance tabs by weld, rivet, bolt, screw, and the like. A counterbalance assembly according to the invention can comprise a variety of shapes and components so long as it is configured to contribute toward a center of gravity of the resistance hanging screen to which it is affixed being located behind the resistance screen. Such that the resistance hanging screen has a bias toward occupying the closed position.

FIG. 4 is a front elevation view of the connector pipe screen 100 illustrated in FIG. 1, with its hanging resistance screen in an open position, installed into catch basin 310 of storm drain 300. Catch basin 310 is positioned below sidewalk 320 and is accessible by removing manhole cover 330 from the opening therefore in sidewalk 320. Surface runoff water enters storm drain 300 by flowing from street 360 into curb inlet opening 340 in curb face 370, into which an automatic retractable screen 350 has been installed. Connector pipe screen 100 is installed on floor 317 and rear wall 315 of catch basin 310 and in front of the outflow connector pipe 325 and in the flow path of water that enters catch basin 310 from inlet opening 340 and exits catch basin 310 by flowing through connector pipe outflow opening 325. During conditions in which a water level in catch basin 310 rise above the top of the fixed section of the front panel 108 of connector pipe screen 100, water pressure against the resistance screen opens the screen as shown which assists storm drain 300 perform its primary functions of preventing erosion and flooding by channeling runoff surface water into stormwater conveyance infrastructure for controlled distribution.

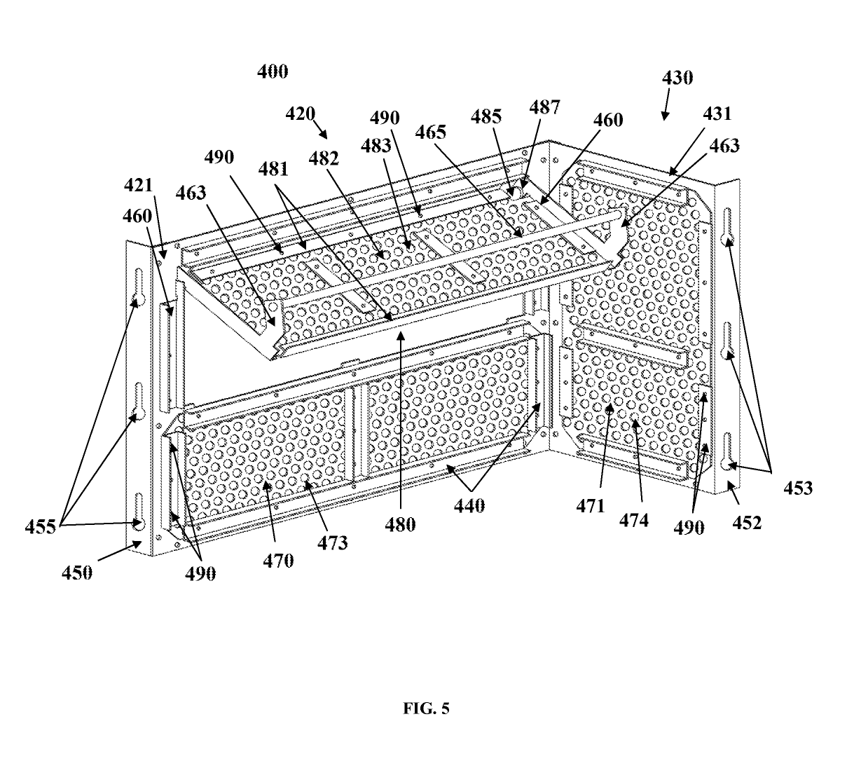

FIG. 5 is a rear elevation view of an embodiment of a connector pipe screen 400 according to the invention that comprises a counterbalanced hanging resistance screen 480 and is configured for installation into a corner of the catch basin of a storm drain. Connector pipe screen 400 possesses a front panel 420, a lateral panel 430, and first and second mounting plates 450 and 452, respectively. Connector pipe screen 400 comprises an overall shape of a box that is open on four sides: i.e., the top side, one lateral side, the bottom side, and the back side.

Front panel 420 comprises front panel metal frame 421 that is made from a single sheet of metal that has been: i. cut to form: a. rivet and screw openings, b. mounting cutouts 455, and c. the openings into which metal screen 470 and hanging resistance screen 480 are installed; and ii. formed into the illustrated shape. First and second resistance screen mounting cantilever brackets 460 are attached to front panel metal frame 421 by rivets 490.

Side panel 430 comprises side panel metal frame 431 that is made from a single sheet of metal that has been: i. cut to form: a. rivet and screw openings, b. mounting cutouts 453, and c. the openings into which metal screen 471 is installed; and ii. formed into the illustrated shape.

Rivets 490 and U-channel structural support brackets 440 fixedly attach metal screens 470 and 471 to front panel metal frame 421 and lateral panel metal frame 431, respectively. U-channel structural support brackets 440 are made of stainless steel.

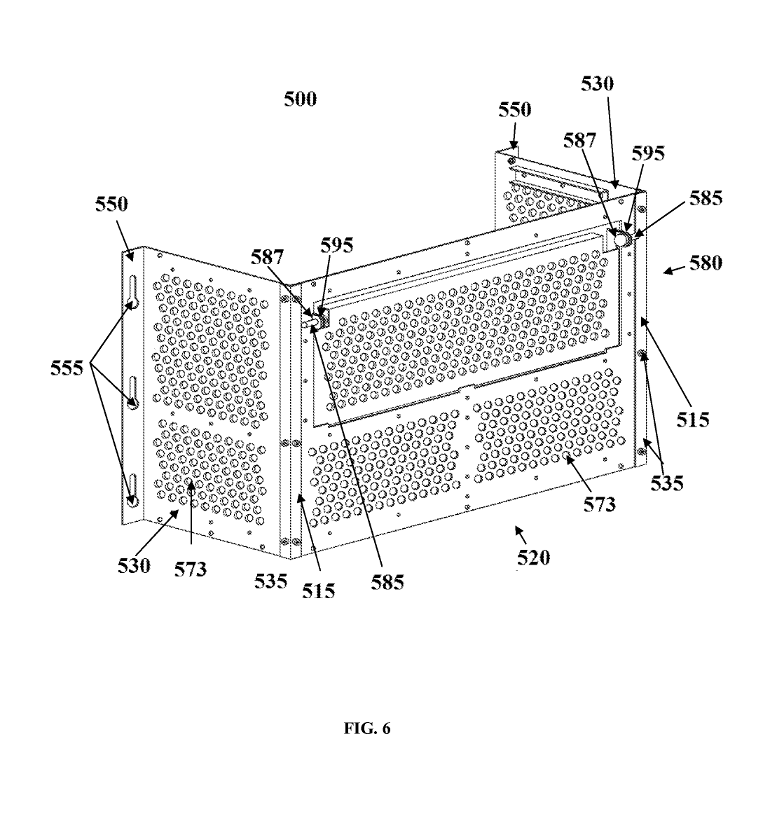

Front panel 420 and lateral panel 430 are fixedly joined by a lateral panel and reinforcement bracket (visible in FIG. 6) and attached with screws.

Metal screens 470 and 471 are made from stainless steel, comprise perforations 473 and 474 respectively, that are adapted in size and shape to allow water to flow through metal screens 470 and impede the flow of at least some water born debris through metal screens 470 and 471.

Counterbalanced resistance hanging screen 480 comprises resistance screen frame 481, which comprises pivot mounting plates 487 (one visible in FIG. 5), and resistance screen 482, which comprises perforations 483 that are adapted in size and shape to allow water to flow through resistance screen 482 and impede the flow of at least some water born debris through resistance screens 482. Resistance screen 482 is attached to resistance screen frame 481 with rivets 493. Resistance screen frame 481 comprises a rectangular shape and is dimensioned for mounting into the opening therefore in metal frame 410 and front panel 420. Resistance screen hanging pivots 485 (one visible in FIG. 5) swingably mount resistance hanging screen 480 into the opening therefor in metal frame 410 and front panel 420 by passing through openings therefor in pivot tabs 495.

Resistance screen frame 481, resistance screen hanging pivots 485, hanging pivot mounting plates 487, and resistance screen 481 are made of stainless steel. Counterbalanced resistance hanging screen 480 possesses a counterbalance assembly, which comprises counterbalance tabs 463 and counterbalance bar 465. Counterbalance tabs 463 are made of stainless steel, extend rearward from resistance screen frame 481, and support counterbalance bar 465. Counterbalance bar 465 is fixedly attached to counterbalance tabs 463 and is made of stainless steel.

A majority of the mass of resistance hanging screen 480 resides in resistance counterbalance tabs 463 and counterbalance bar 465. Accordingly, the center of gravity of resistance hanging screen 480 is located between resistance screen 482 and a plane that is parallel to resistance screen 482 and bisects counterbalance bar 465 when resistance hanging screen 482 is in the closed position. The combination of having a so-located center of gravity and being swingably mounted in the storm drain connector pipe screen 400 results in resistance hanging screen 480 having a bias towards occupying the closed position when mounted in a hanging fashion in connector pipe screen 400.

Such a closed position bias results in resistance hanging screen 480 having a tendency to remain closed under dry conditions and conditions of no or low water flow through connector pipe screen 480. Under conditions of no to low water flow through screen 482, water pressure exerted on resistance screen 482 and resistance screen frame 481 is insufficient to overcome the closed position bias of resistance hanging screen 480. In a closed position, debris carried by water flowing through resistance hanging screen 480 and of a size too large to flow through perforations 483 is impeded from flowing through resistance hanging screen 480 such that it collects in a catch basin of a storm drain into which connector pipe screen 480 is installed without flowing into a connector pipe of a storm drain into which connector pipe screen 400 is installed. Such collected debris can be removed from the catch basin by maintenance crews. Accordingly, hanging resistance screen 480 reliably assumes a closed position in dry conditions and in conditions of low water flow therethrough; and is therefore reliably operative for its intended filtering function.

Under conditions of moderate to high water flows through resistance hanging screen 480, water pressure exerted on resistance screen 482 and resistance screen frame 481 are sufficient to cause hanging resistance screen 480 to swing on hanging pivots 485 into the illustrated open position. In the open position, significantly increased amounts of water flow through connector pipe screen 400 than would flow if hanging resistance screen 480 were fixedly mounted to the connector pipe screen 400 in a closed position. In this way, hanging resistance screen 480 assists the storm drain into which connector pipe screen 400 is installed to perform its primary functions of preventing erosion and flooding by channeling runoff surface water into stormwater conveyance infrastructure for controlled distribution. Upon abatement of moderate to high water flows through resistance hanging screen 480, resistance hanging screen 480 swings with bias on hanging pivots 485 into the closed position.

FIG. 6 is a front elevation view of an embodiment of a connector pipe screen 500 according to the invention that comprises a forward mounted resistance hanging screen 580 and is configured for installation into the catch basin of a storm drain. Connector pipe screen 500 possesses a front panel 520, first and second lateral panels 530, first and second mounting plates 550, and first and second resistance hanging screen mounting bracket cantilevers ([visible in FIG. 5). First and second resistance hanging screen mounting cantilever brackets comprise pivot tabs 595 that project frontward from front panel 520.

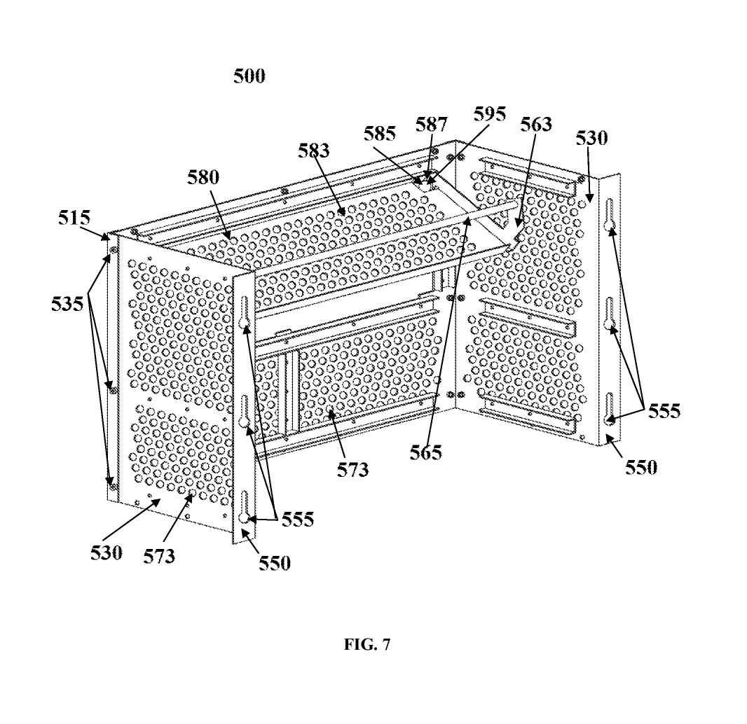

Connector pipe screen 500 possesses an overall shape of a box that is open on three sides: i.e., the top side, the bottom side, and the back side (also see FIG. 7). Connector pipe screen 500 is made from a single sheet of metal that has been: i. stamped to make perforations 573 in front panel 520 and side panels 530; ii. cut to form: a. rivet and screw openings, b. mounting cutouts 555, and c. the opening into which hanging resistance screen 580 is installed; and iii. formed into the illustrated shape.

First and second mounting plates 550 possess mounting cutouts 555 adapted to receive bolts or screws for fixedly mounting connector pipe screen 500 into the catch basin of a storm drain (also see FIGS. 7 and 4). Perforations 573 are adapted in size and shape to allow water to flow through panels 520 and 530 and resistance screen 580 to impede the flow of at least some water born debris through connector pipe screen 500.

Connector pipe screen 500 possesses front and lateral panel reinforcement and connection members 515 made of stainless steel and join connector pipe screen 500 at the junctions of front panel 520 and first and second lateral panels 530 by screws 535. Reinforcement and connection members 515 are adapted to increase the strength of connector pipe screen 500. In some embodiments, connector pipe screens do not comprise reinforcement members. In some embodiments reinforcement members are attached to frames by welding, screws, bolts, clamps, pins, and the like.

Referring again to FIG. 6, resistance hanging screen 580 comprises first and second pivot mounting plates 587, and screen perforations 573 that are adapted in size and shape to allow water to flow through resistance hanging screen 580 and impede the flow of at least some water born debris through resistance hanging screen 580. Resistance hanging screen 580 comprises a rectangular shape and is dimensioned for mounting into the opening therefore in front panel 520. Resistance screen hanging pivots 585 swingably mount resistance hanging screen 580 into the opening therefore in front panel 520 by passing through openings in resistance screen mounting cantilever brackets (not shown) and hanging pivot mounting plates 587. Hanging pivots 585, hanging pivot mounting plates 587, and resistance hanging screen 580 are made of stainless steel.

Hanging pivot mounting plates 587 project frontward of resistance hanging screen 580 and front panel 520. Accordingly, the center of gravity of resistance hanging screen 580 is located between resistance hanging screen 580 and a plane that is parallel to resistance hanging screen 580 and bisects hanging pivots 585, when resistance hanging screen 580 is in the illustrated closed position. The combination of having a so-located center of gravity and being swingably mounted in storm drain connector pipe screen 500 results in resistance hanging screen 580 having a bias towards occupying the illustrated closed position.

Such a closed position bias results in resistance hanging screen 580 having a tendency to remain closed under conditions of no to low water flow through resistance hanging screen 580. Under conditions of no to low water flow through resistance hanging screen 580, water pressure exerted thereon is insufficient to overcome the closed position bias of resistance hanging screen 580. In a closed position, debris carried by water flowing through resistance hanging screen 580 of a size too large to flow through perforations 573 is impeded from flowing through resistance hanging screen 580 such that it collects in a catch basin of a storm drain (see FIG. 4) into which connector pipe screen 500 is installed without flowing into a connector pipe (see FIG. 4) of a storm drain into which connector pipe screen 500 is installed. Such collected debris can be removed from the catch basin by maintenance crews. Accordingly, hanging resistance screen 580 reliably assumes a closed in conditions of no to low water flow therethrough; and is therefore reliably operative for its intended filtering function.

Under conditions of moderate to high water flows through resistance hanging screen 580, water pressure exerted on hanging resistance screen 580 is sufficient to cause hanging resistance screen 580 to swing on hanging pivots 585 into an open position (see FIG. 7). In the open position, significantly increased amounts of water flow through connector pipe screen 500 than would flow if hanging resistance screen 580 were fixedly mounted to the connector pipe screen 500 in a closed position. In this way, hanging resistance screen 580 assists the storm drain into which connector pipe screen 500 is installed to perform its primary functions of preventing erosion and flooding by channeling runoff surface water into stormwater conveyance infrastructure for controlled distribution. Upon abatement of moderate to high water flows through resistance hanging screen 580, resistance hanging screen 580 swings with bias on hanging pivots 585 into the closed position.

FIG. 7 is a rear elevation view of the connector pipe screen 500 illustrated in FIG. 6, and shows that connector pipe screen 500 possesses a counterbalance assembly, which comprises counterbalance tabs 563 (one visible in FIG. 7) and counterbalance bar 565. Counterbalance tabs 563 are made of stainless steel, are fixedly attached to resistance hanging screen 580, extend rearward from resistance hanging screen frame 580, and support counterbalance bar 565. Counterbalance bar 565 is also made of stainless steel and is fixedly attached to counterbalance tabs 563. The additional mass of the counterbalance balance assembly increases the bias towards occupying the closed position of the resistance hanging screen 580.

The present invention is not limited to the CPSs illustrated in the figures and described above. The present invention extends to CPSs that are configured for instillation into the flow path of surface runoff water through the catch basin of a storm drain that comprise a rotatably mounted resistance screen. CPSs of the invention are configured to impede the passage of surface runoff water born debris from entering into the water conveyance infrastructure downstream of storm drains.

CPSs of the invention possess at least one rotatably mounted resistance screen that has a bias toward occupying a closed position in which it is operative to impede the passage of surface runoff water born debris from entering into the water conveyance infrastructure downstream of storm drains. The bias toward occupying the closed position of rotatably mounted resistance screens of the invention can be overcome by the exertion of pressure thereon by water flowing therethrough. Means for achieving the bias toward occupying the closed position of rotatably mounted resistance screens of the invention include, in addition to those illustrated and described above can include springs, magnets, torsion devices, pulley and weight systems, elastic bands, and the like, alone or in combination.

Rotatably mounted resistance screens of the invention can be mounted onto CPSs of the invention such that they swing to an open position by rotating horizontally in either direction (i.e., left or right) or by rotating vertically in either direction (i.e., up or down). Means for mounting resistance screens onto CPSs and achieving such horizontal or vertical rotation include appropriately positioned and configured bolts, pivots, hinges, pistons, and the like, alone or in combination.

Conditions of low water flow through a CPS of the invention are those that are insufficient to exert an amount of pressure on a rotatably mounted resistance screen to cause it to occupy an open position. Such amounts of pressure can vary according to the needs of different installation sites, and can be less than about 50 psi, less than about 45 psi, less than about 40 psi, less than about 35 psi, less than about 30 psi, less than about 25 psi, less than about 20 psi, less than about 10 psi, and less than about 5 psi. Conditions of moderate to high water flow through a CPS of the invention are those that are sufficient to exert an amount of pressure on a rotatably mounted resistance screen to cause it to occupy an open position. Such amounts of pressure can vary according to the needs of different installation sites, and can be greater than about 5 psi, greater than about 10 psi, greater than about 15 psi, greater than about 20 psi, greater than about 25 psi, greater than about 30 psi, greater than about 35 psi, greater than about 40 psi, greater than about 45 psi, and greater than about 50 psi.

CPSs of the invention need not possess a box shape, but rather may comprise any shape, such as cylindrical, circular, triangular, and flat. In addition, rotatably mounted resistance screens of CPSs of the invention need not be substantially comprised of a screen, but can be substantially or entirely made of solid material through which water cannot pass. Therefore, as used herein, the term “rotatably mounted resistance screen” is defined to include completely solid panels. Similarly, frames of CPSs of the invention into which rotatably mounted resistance screens of the invention are installed need not be substantially comprised of openings into which screens are installed, but can be substantially or entirely made of solid material through which water cannot pass. The exception being that CPS frames that form a single panel are not made entirely of solid material through which water cannot pass.

In some embodiments, metal frames, resistance screen mounting cantilevers, resistance screen frames, and metal screens of connector pipe screens of the present invention are made from stainless steel or galvanized steel. In some embodiments, metal screens can comprise grate or slat perforation patterns. In some embodiments, front section, side sections, resistance screen mounting cantilevers, and mounting plates of connector pipe screens of the invention are made from multiple pieces of metal shaped to form subcomponent parts therefore and then joined together by weld, rivet, bolt, screw, and the like into a connector pipe screen. In some embodiments metal screens are mounted to metal frames of connector pipe screens of the invention by weld, bolt, screw, clamp, and the like. In some embodiments, metal screens and cutouts therefore in metal frames, or subcomponents thereof, comprise shapes that are substantially square, rectangular, circular, oval, triangular, pentagonal, hexagonal, and the like.

The amount of bias that forward mounted resistance hanging screens show toward occupying the closed position can be adjusted by adjusting a variety of parameters, such as the weight of a resistance hanging screen, the extent to which resistance screen hanging pivots project frontward of a resistance hanging screen, and the weight of a resistance screen frame. Similarly, the amount of bias that counterbalanced resistance hanging screens show toward occupying the closed position can be adjusted by adjusting a variety of parameters, such as the weight of the resistance hanging screen, the extent to which a counterbalance assembly projects rearward of the resistance hanging screen, the weight of the counterbalance assembly, and the weight of a resistance screen frame.

The figures illustrate preferred embodiments of the present invention. The present invention is not, however, limited to the preferred embodiments illustrated in the figures. The skilled artisan will recognize the interchangeability of various features from different embodiments. Although the disclosure has been provided in the context of certain embodiments and examples, it will be understood by those skilled in the art that the disclosure extends beyond the specifically described embodiments to other alternative embodiments and/or uses and obvious modifications and equivalents thereof. Accordingly, the disclosure is not intended to be limited by the specific disclosures of embodiments herein.

What is claimed is:

1. A connector pipe screen (CPS), configured for installation into a catch basin of a storm drain, comprising a panel possessing a resistance screen, means for rotatably mounting the resistance screen onto the panel, and means for imparting on the resistance screen a bias towards occupying a closed position, wherein:
the panel comprises an opening into which the resistance screen is rotatably mounted;
the means for imparting on the resistance screen the bias towards occupying the closed position connects the panel and the resistance screen such that the resistance screen rotates to: i. the closed position when low amounts of water flow through the resistance screen, and ii. an open position when moderate or high amounts of water flow through the resistance screen; and
the screen possesses a plurality of perforations adapted in size and shape to permit water to pass through the screen and impede debris from passing through the screen.

2. The CPS of claim 1, wherein the means for imparting on the resistance screen the bias toward occupying a closed position is selected from the group consisting of a frontward pivot mounted resistance hanging screen, a counterbalanced resistance hanging screen, and a frontward pivot mounted and counterbalanced resistance hanging screen.

3. The CPS of claim 1, wherein the means for imparting on the resistance screen the bias towards occupying the closed position is selected from the group consisting of a spring, a magnet, a torsion device, a piston, a pulley and weight system, an elastic band, and a combination thereof.

4. The CPS of claim 1, wherein the low amounts of water flow through the resistance screen exert less than about 15 pounds of pressure per square inch (psi) on the resistance screen.

5. The CPS of claim 1, wherein the moderate or high amounts of water flow through the resistance screen exert greater than about 15 pounds of pressure per square inch (psi) on the resistance screen.

6. The CPS of claim 1, wherein the means for mounting the resistance screen on the panel is selected from the group consisting of a bolt, a pivot, a hinge, and a combination thereof.

7. The CPS of claim 1, wherein the means for mounting the resistance screen on the panel is a piston.

8. The CPS of claim 1, wherein the resistance screen is rotatably mounted in the panel such that the resistance screen rotates in a horizontal manner.

9. The CPS of claim 1, wherein the resistance screen is rotatably mounted in the panel such that the resistance screen rotates in a vertical manner.
